(19) United States
(12) Patent Application Publication
(10) Pub. No.: US 2003/0077456 A1
(43) Pub. Date: Apr. 24, 2003

(54) Sol-gel based films

(76) Inventors: Graham Atkins, Downer (AU); Barry Luther-Davies, Kambah (AU); Robert Bruce Charters, Palmerston (AU); Anna Samoc, Lyons (AU); Marek Julian Samoc, Lyons (AU)

Correspondence Address: LARSON & TAYLOR, PLC, 1199 NORTH FAIRFAX STREET, SUITE 900, ALEXANDRIA, VA, 22314, US

(21) Appl. No.: 10/149,999

(22) PCT Filed: Dec. 7, 2000
(86) PCT No.: PCT/AU00/01507

(30) Foreign Application Priority Data
Dec. 16, 1999 (AU) PQ4696

(51) Int. Cl. B32B 9/00; G02B 6/10

(52) U.S. Cl. 428/428; 385/130

(57) ABSTRACT

The present invention provides a device comprising a substrate, a buffer layer formed on a surface of the substrate, and a sol-gel based film deposited on the buffer layer, wherein the buffer layer provides an interface between the substrate and film and exhibits two distinct phases, a deformable phase at an elevated temperature sufficient to dry the film, and a stable, relatively non-deformable, phase at a lower temperature, and wherein, when in the deformable phase, the buffer layer accommodates differential movement over its thickness to an extent sufficient to prevent cracking of the film as it dries.

### FIELD OF THE INVENTION

The present invention concerns devices which incorporate a sol-gel based film.

### BACKGROUND OF THE INVENTION

Sol-gel processing is one of many methods available for producing silica-on-silicon films for eg. planar waveguides for integrated optics. One of the advantages it offers is that it is a simple deposition process which does not require a complex deposition procedure. Typically, it involves immersion of a substrate into a sol-gel containing an inorganic silicate to “coat” the substrate with a film. Alternative sol-gel processing may involve involve spin-coating or filtration processes.

A problem with sol-gel processing is that the films have to be dried typically at around 1000° C. to remove water and silanol (SiOH) to bring the optical absorption in the film down to acceptable levels. During the drying process, stress associated with drying-induced shrinkage causes the films to crack unless they are quite thin (typically less than 1 μm). Therefore, in order to build up films of sufficient film thicknesses for integrated optics applications (which typically require several micrometres) it is currently necessary to use a multi-step deposition technique involving several rapid thermal annealing processes.

Recently, organically modified silicates (ormosils) have been used in sol-gel processing. Ormosils offer an additional advantage for optical applications in that they can be dried effectively at much lower temperatures (200° C. and below), which allows deposition directly onto structures which may already comprise semiconductor-based optical components. However, whilst ormosils are less susceptible to drying-induced cracking, deposition of films of sufficient thickness for optical applications can still not be performed reliably in a one-step process.

Therefore, there is a need for further improvement in sol-gel processing.

### SUMMARY OF THE INVENTION

The present invention provides a device comprising a substrate, a buffer layer formed on a surface of the substrate, and a sol-gel based film deposited on the buffer layer, wherein the buffer layer provides an interface between the substrate and film and exhibits two distinct phases, a deformable phase at an elevated temperature sufficient to dry the film, and a stable, relatively non-deformable, phase at a lower temperature, and wherein, when in the deformable phase, the buffer layer accommodates differential movement over its thickness to an extent sufficient to prevent cracking of the film as it dries.

The differential movement of the buffer layer is a result of a change in the sol-gel film dimensions relative to the substrate. Typically, the sol-gel film shrinks relative to the substrate.

Accordingly, the occurrence of cracks can be avoided, and stresses that may be present in the buffer layer as a result of accommodating the shrinkage or expansion of the sol-gel film can be reduced upon cooling down after the drying.

The buffer layer may be arranged to elastically deform in the deformable phase at the elevated temperature.

Alternatively, the buffer layer may be arranged to plastically deform in the deformable phase at the elevated temperature.

Where the film is formed from inorganic silicates, the buffer layer may be in the deformable state at temperatures of the order of 1000° C.

Where the film is formed from organically modified silicates, the buffer layer may be in the deformable state at temperatures of about 200° C.

Where the sol-gel film is to be utilised as a waveguide in the device, the buffer layer may further be arranged to have low optical absorption properties at a selected wavelength. In that way, the buffer layer can fulfil dual purposes of a) relieving stress during the drying, and b) providing an optical separation layer.

The substrate may be silicon-, gallium arsenide-, glass- or sapphire-based.

Where the elevated temperature is in a range from about 100 to 300° C., the buffer layer may comprise a polymer, or an ormosil. The polymer may comprise PMMA or PVP.

Preferred forms of the invention will now be described, by way of example only, with reference to the accompanying drawings, in which:

### BRIEF DESCRIPTION OF THE DRAWINGS

FIGS. 1a to c are schematic drawings illustrating the use of a device embodying the present invention.

FIG. 2 is a schematic of an ormosil structure used to form a sol-gel film in an embodiment of the present invention.

### DETAILED DESCRIPTION OF THE PREFERRED EMBODIMENT

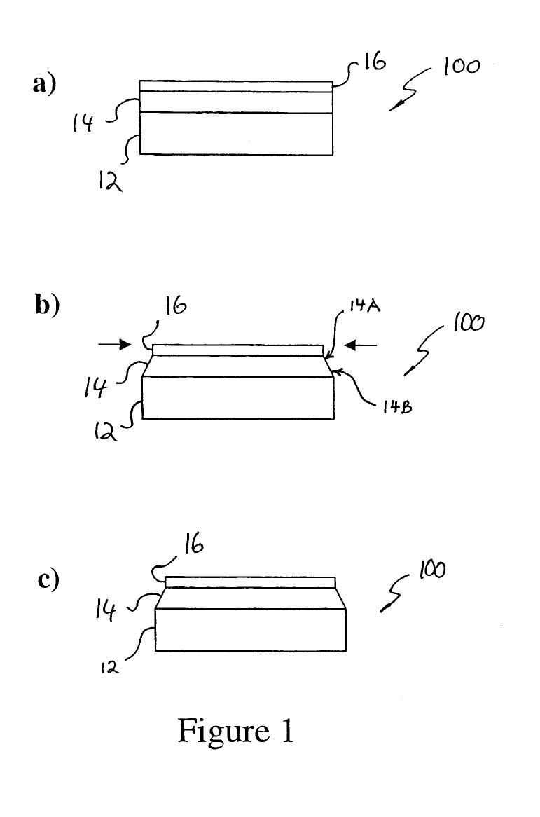

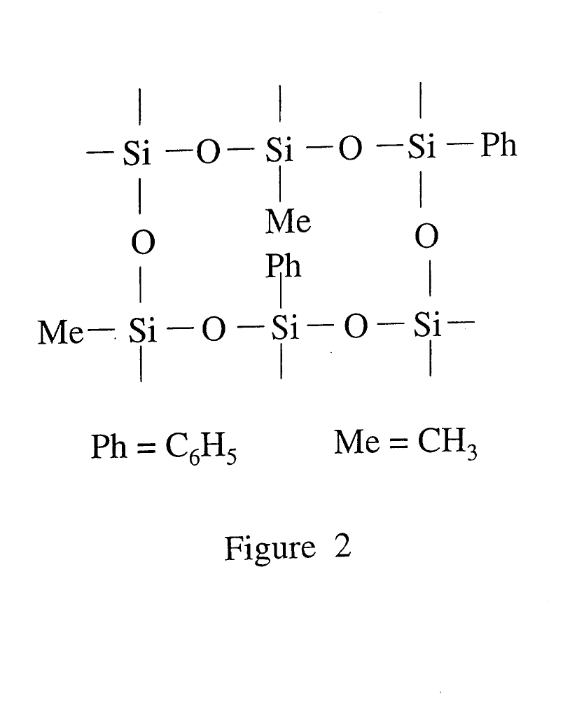

In FIG. 1a, device 100 comprises a silicon wafer 12 on which is formed a buffer layer in the form of a polymer layer 14. On top of the polymer layer 14, an ormosil layer 16 has been deposited using sol-gel processing. The ormosil structure used in ormosil layer 16 is shown in FIG. 2 (phenyl/methyl substituted silica).

During heating of the device 100 to effect drying of the ormosil film 16 at an elevated temperature, drying-induced shrinkage of the ormosil film 16 occurs. This would typically result in stresses being induced in the film because the bonds to a “rigid” substrate layer would not permit differential movement between the film and the substrate. This in turn could result in cracking of the ormosil layer 16. “Reversible” stresses may also be induced due to different thermal expansion coefficients of the various materials, however, it is the permanent drying-induced shrinkage that has been found to be the cause of cracking in sol-gel based films.

In the preferred embodiment illustrated in FIG. 1b, the polymer buffer layer 14 is arranged to be soft and therefore deformable at the drying temperature. This enables elastic deformation of the polymer layer 14, and thus differential movement over it thickness, i.e. upper regions 14A of the polymer film 14 which are closest to the polymer-ormosil interface contract more than lower regions 14B closest to the substrate-polymer interface. Accordingly, the tendency for cracks to form in the ormosil layer 16 during the drying process is avoided.

Finally, as illustrated in FIG. 1c, after the cooling down of the entire structure to about room temperature, the polymer buffer layer 14 returns to a solid state, thereby providing a “stable” substrate for the dried ormosil film 16. The return to a solid state effectively “freezes” the polymer layer 14, i.e. making it harder and resistant to deformation. This reduces any stresses that may be present at the interface between the film 16 and the polymer layer 14 caused by the shrinkage.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

The claims defining the invention are

1. A device comprising a substrate, a buffer layer formed on a surface of the substrate, and a sol-gel based film deposited on the buffer layer, wherein the buffer layer provides an interface between the substrate and film and exhibits two distinct phases, a deformable phase at an elevated temperature sufficient to dry the film, and a stable, relatively non-deformable, phase at a lower temperature, and wherein, when in the deformable phase, the buffer layer accommodates differential movement over its thickness to an extent sufficient to prevent cracking of the film as it dries.

2. A device as claimed in claim 1, wherein the buffer layer is arranged to elastically deform in the deformable phase at the elevated temperature.

3. A device as claimed in claim 1, wherein the buffer layer is arranged to plastically deform in the deformable phase at the elevated temperature.

4. A device as claimed in claim 1, wherein the buffer layer is arranged to be in the deformable phase at temperatures of the order of 1000° C.

5. A device as claimed in claim 4 wherein the buffer layer is formed from an inorganic silicate.

6. A device as claimed in claim 1, wherein the buffer layer is arranged to be in the deformable phase at temperatures of about 200° C.

7. A device as claimed in claim 4 wherein the buffer layer is formed from an organically-modified silicate.

8. A device as claimed in any one of the preceding claims, wherein the buffer layer is further arranged to have low optical absorption properties at a selected wavelength.

9. A device as claimed in any one of the preceding claims, wherein the substrate comprises a material from a group comprising silicon-, gallium arsenide-, glass- or sapphire-based materials.

10. A device as claimed in claim 1 wherein the buffer layer comprises a polymer.

11. A device as claimed in claim 1 wherein the buffer layer comprises an ormosil.
